(19) United States
(12) Patent Application Publication
(10) Pub. No.: US 2001/0034633 A1
(43) Pub. Date: Oct. 25, 2001

(54) Real-time on-line competitiveness analysis

(76) Inventor: Roger P. Hoffman, Green Bay, WI (US)

Correspondence Address: Weiss & Weiss / Philip M. Weiss, Suite 305, 500 Old Country Road, Garden City, NY, 11530, US

(21) Appl. No.: 09/795,427

(22) Filed: Feb. 28, 2001

Related U.S. Application Data
(60) Provisional application No. 60/185,961, filed on Mar. 1, 2000.

(51) Int. Cl. G06F 17/60

(52) U.S. Cl. 705/8

(57) ABSTRACT

The present invention relates to a competitive analysis system that creates a database of information regarding a manufacturing facility or product segment within an industry.

### FIELD OF THE INVENTION

The present invention relates to a competitive analysis system that creates a database of information regarding a manufacturing facility or product segment within an industry.

### BACKGROUND OF THE INVENTION

There exists in the prior art industry studies on competitive advantages. For example, Jacob Sirrine Consulting Group provides a competitive cost analysis of nearly every pulp and papermaking facility in the World. This study provides flow diagrams that breakout the consumption and cost of manufacturing inputs such as wood, chemicals, energy, labor and other supplies for each facility. This study takes this cost data and ranks each mill within a particular grade segment of the industry. For example, newsprint producers can obtain a study that ranks the competitiveness of all newsprint mills. There are other types of similar competitive studies.

The problem with the prior art studies is that customers do not get information on a timely basis relating to current competitiveness. While each facility's process is relatively fixed so that the quantity of inputs does not change, the per-unit cost of inputs can change on a daily basis. For example papermaking facility X may use 4.3 tons of wood for each ton of paper made. While this usage remains relatively fixed until that facility's process changes, the price of wood may change on a weekly basis (particularly when foreign currency changes are involved). As such, the relative competitiveness with facility Y which uses 4.1 tons of wood per ton of paper is different based on the cost of wood (i.e. facility X has a greater disadvantage as the price of wood increases). While the prior art may provide for relatively numerous updates, such as quarterly updates, it is both inefficient and not sufficiently current.

### SUMMARY OF THE INVENTION

The present invention relates to a competitive analysis system that creates a database of information regarding a manufacturing facility within an industry. It is an object of the present invention to provide relative cost competitiveness of each facility within an industry or product segment within an industry. It is an object of the present invention to provide cost competitive information, which includes but is not limited to usage inputs of materials necessary to manufacture a product, including labor. Such information can be further broken down to particular manufacturing lines within a facility. It is an object of the present invention to obtain the current market price of per-unit costs of input usages either manually from current periodicals or more efficiently and timely from on-line Internet information sources, including foreign currency valuation changes. The current prices can then be applied to the usage database. The present invention allows for the computation of the usage information with the current price of usage costs to recompute in real-time the current competitiveness of a particular industry or subindustry, including competition expressed in any country's currency. This real-time competitiveness would be available to users by transmitting information on the Internet.

Users of the present invention can have the usage database with only current prices transmitted to them for computing at the customer's location. More efficiently, however, the computing of the competitiveness can occur at a central location with a transmitting of the resulting data to the user. This later method is more efficient as the database can be updated and controlled centrally.

It is an object of the present invention to provide the information to users to allow them to manipulate the data to create their own tailored analysis.

### DETAILED DESCRIPTION OF THE INVENTION

For example, a paper making facility may have three paper making machines that manufacture newsprint. The database of the present invention can have usage inputs for each machine of each facility so that the competitiveness of each newsprint machine can be analyzed. For example, the invention can indicate to the facility X's management that facility X's three paper machine lines manufactures grade of paper at the 15^{th}, 50^{th} and 70^{th} lowest cost grade manufacturing lines in the industry of 500 machine lines, at the current time with real pricing. Facility X management can also identify which paper machines are the other 497 machines in the ranking. One benefit of the invention is that if a price change of an input changes, the subscriber will immediately know the impact. For example, if wastepaper prices increase (a raw material used to make recycled pulp), facility X management can immediately go on-line to the system of the present invention and get a recomputed competitiveness analysis. They may find that their machine that ranked 15^{th} has now moved up to 12^{th} due to a waste-paper increase, since facility X uses less waste paper. This information would be particularly valuable if the machines that they passed up (the formerly ranked 13^{th} and 14^{th} machines) were fierce competitors in which facility X was competing to secure business.

Customers for this service would be not only the manufacturers but other interested parties as well such as the financial investment community. The present invention makes it possible to group machines, facilities, even if they make different products, by company. The present invention can rank relative profitability of the manufacturing companies, for example, those that make paper and steel. The present invention can group regions of the world so that a relative competitiveness by region can be established in real time.

While the above example refers to the paper industry, the present invention can be applied to any relevant manufacturing industry including, but not limited to: steel, other metals, petroleum, and chemicals.

In a further embodiment, the system can provide a “fantasy” system wherein users can change the information regarding their usage inputs, not their actual usage inputs, but other numbers, to help a manufacturer determine why others in their industry are more competitive. This can assist a manufacturer in determine what items they purchase, use, etc.

1. A competitive analysis system comprising:
a database of information regarding manufacturing facilities within an industry;
information regarding cost competitiveness of each facility within an industry or product segment within an industry.
said cost competitive information, includes but is not limited to usage inputs of materials necessary to manufacture a product
said database computing the usage information with current price of usage costs real-time.

2. The system of claim 1 wherein said cost competitive information is broken down to particular manufacturing lines within a facility.

3. The system of claim 1 wherein said cost competitive information is found from on-line Internet information sources.

4. The system of claim I further comprising a foreign currency valuation system.

5. The system of claim 1 wherein said system allows a user to input usage inputs of materials different than current usage inputs of a manufacturer.

6. The system of claim 5 wherein said system calculates competitiveness of a manufacturing facility based on usage inputs of materials different than current usage inputs of a manufacturer.

7. The system of claim 1 wherein relative competitiveness of a corporation is computed by summation of profitability of said facilities of said corporation.
